(19) United States
(12) Patent Application Publication
(10) Pub. No.: US 2011/0111798 A1
(43) Pub. Date: May 12, 2011

(54) REGISTRATION METHOD OF REFERENCE GESTURE DATA, DRIVING METHOD OF MOBILE TERMINAL, AND MOBILE TERMINAL THEREOF

(75) Inventors: Jong Hong Jeon, Daejeon (KR); Seung Yun Lee, Daejeon (KR); Kang Chan Lee, Daejeon (KR); Sung Han Kim, Daejeon (KR); Won Suk Lee, Daejeon (KR); Min Kyo In, Daejeon (KR)

(73) Assignee: Electronics and Telecommunications Research Institute, Daejeon (KR)

(21) Appl. No.: 13/000,965

(22) PCT Filed: Jan. 23, 2009
(86) PCT No.: PCT/KR09/00369

§ 371 Date: Dec. 22, 2010

(30) Foreign Application Priority Data
Jun. 24, 2008 (KR) 10-2008-0059573

(51) Int. Cl. H04W 88/02

(52) U.S. Cl. 455/556.1

(57) ABSTRACT

The present invention relates to a reference gesture registering method, a mobile terminal (100) driving method, and a mobile terminal (100) thereof. In the present invention, when a user uses a keypad or a touch screen to request to recognize a gesture or register a gesture of a user, a mobile terminal (100) analyzes a user gesture image input through a camera (120) attached to the mobile terminal (100) to extract gesture data, and executes an application function mapped to the extracted gesture data or registers the extracted gesture data as reference gesture data that serves as a gesture identification reference.

### TECHNICAL FIELD

The present invention relates to a registration method of reference gesture data, a driving method of a mobile terminal, and a mobile terminal thereof.

The present invention was supported by the Ministry of Knowledge Economy (NIKE) and the Institute for Information Technology Advancement (IITA) [2008-P1-22-08J30, Development of Next Generation Web standard].

### BACKGROUND ART

At the present time, users use various types of mobile terminals. Examples of the mobile terminals include portable phones, personal digital assistants (FDA), portable multimedia players (PMP), moving picture experts group audio layer-3 players (MP3P), digital cameras, and the like.

In general, a mobile terminal provides a user interface through buttons or a keypad to which directional key functions are designated. In recent years, as a touch screen is generally used in the mobile terminal, the mobile terminal provides a user interface that can be changed in various forms.

Meanwhile, since this type of mobile terminal should be provided with a display device for information transmission and an input unit for information input in a small space, it is difficult to use a user interface, such as a mouse, differently from a personal computer. Accordingly, when a user uses a mobile application that requires a complex screen movement, such as mobile browsing, through the mobile terminal, it is inconvenient for the user. For example, when the user uses mobile browsing using a keypad, the user needs to press a plurality of buttons in order to move a screen, which is inconvenient for the user, When the user uses a mobile application using a touch pad, the user should use both hands to operate the mobile terminal. Thus, it is not possible to meet a demand from the user who desires to operate the mobile terminal using only one hand.

Accordingly, a method that provides an effective interface for a user in a mobile terminal becomes very important to accelerate a utilization of mobile applications including mobile browsing. Thus, it is required to develop a new interface technology.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a reference gesture data registering method, a mobile terminal driving method, and a mobile terminal thereof, having advantages of being more convenient for a user.

### Technical Solution

An exemplary embodiment of the present invention provides a mobile terminal driving method that drives a mobile terminal, which has a camera attached thereto and recognizes gestures of a user. The mobile terminal driving method includes collecting gesture images through the camera, generating gesture data that includes motion information where positional changes of identifiers in the collected gesture images are recorded, and when the gesture data can be identified, searching an application function mapped to the gesture data and executing the searched application function.

Another embodiment of the present invention provides a reference gesture registering method in which a mobile terminal having a camera attached thereto registers reference gesture data that is used as a reference when identifying gestures of a user. The reference gesture registering method includes collecting gesture images through the camera during a recognition interval, analyzing the collected gesture images to extract at least one feature point, recording positional changes of identifiers recognized on the basis of the at least one feature point and generating motion information, generating gesture data including the motion information, and mapping an application function selected by the user to the gesture data and storing mapping information.

Yet another embodiment of the present invention provides a mobile terminal. The mobile terminal includes an image processor that uses positional changes of identifiers in gesture images of a user input through a camera attached to the mobile terminal to extract gesture data, a gesture analyzer that outputs a control instruction to drive an application function mapped to reference gesture data matched with the gesture data when there is the reference gesture data matched with the gesture data among at least one reference gesture data that is previously stored in the mobile terminal, and a driver that executes the application function on the basis of the control instruction.

### ADVANTAGEOUS EFFECTS

According to the exemplary embodiments of the present invention, a mobile terminal recognizes gestures of a user input through an incorporated camera, drives various functions, such as a screen movement of a mobile browser and screen enlargement/reduction, and a plurality of other application functions according to the recognized gestures. As a result, it becomes more convenient for a user when the user uses the mobile terminal.

### BRIEF DESCRIPTION OF DRAWINGS

FIG. 1 is a configuration diagram illustrating a mobile terminal according to an exemplary embodiment of the present invention.

FIG. 2 is a configuration diagram illustrating a gesture processing unit according to an exemplary embodiment of the present invention.

FIG. 3 is a configuration diagram illustrating an image processor according to an exemplary embodiment of the present invention.

FIG. 4 is a diagram illustrating examples of identifiers according to an exemplary embodiment of the present invention.

FIG. 5 is a diagram illustrating examples of motion information that is generated on the basis of positional changes of identifiers according to an exemplary embodiment of the present invention.

FIG. 6 is a diagram illustrating examples of gesture data according to an exemplary embodiment of the present invention.

FIG. 7 is a configuration diagram illustrating a gesture analyzer according to an exemplary embodiment of the present invention.

FIGS. 8 to 11 are diagrams illustrating examples of a mobile terminal according to an exemplary embodiment of the present invention.

FIG. 12 is a diagram illustrating an example of when a mobile terminal according to an exemplary embodiment of the present invention recognizes gestures of a user.

FIG. 13 is a flowchart illustrating a method of driving a mobile terminal in a gesture recognition mode according to an exemplary embodiment of the present invention.

FIG. 14 is a flowchart illustrating a method in which a mobile terminal registers gestures of a user in a gesture registration mode according to an exemplary embodiment of the present invention.

FIG. 15 is a flowchart illustrating a method in which a mobile terminal according to an exemplary embodiment of the present invention generates gesture data.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” and “comprising”, will be understood to imply the inclusion of stated elements but not the exclusion of any other elements. In addition, the terms “-er” and “-or” described in the specification mean units for processing at least one function and operation and can be implemented by hardware components, software components, or combinations thereof.

Hereinafter, a reference gesture data registering method, a mobile terminal driving method, and a mobile terminal thereof according to an exemplary embodiment of the present invention will be described in detail with reference to the accompanying drawings.

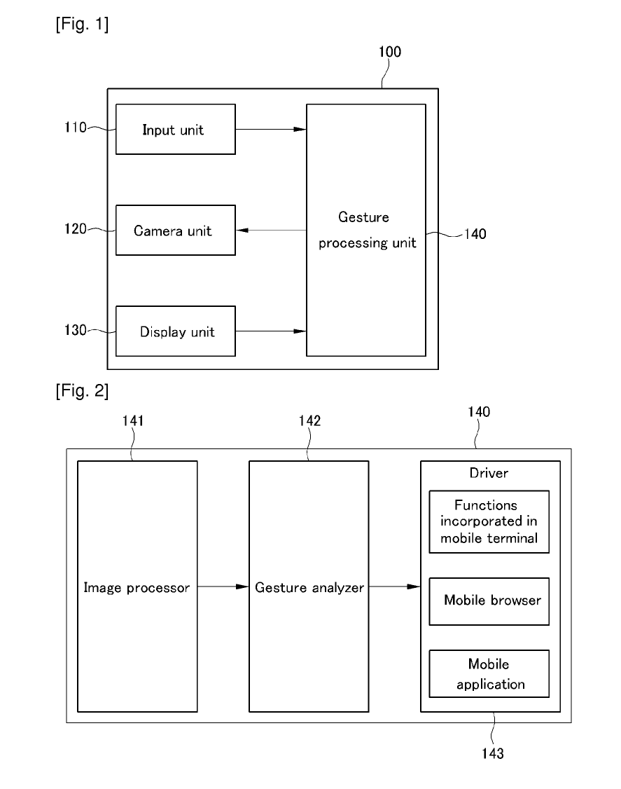

FIG. 1 is a configuration diagram illustrating a mobile terminal 100 according to an exemplary embodiment of the present invention

Referring to FIG. 1, the mobile terminal 100 includes an input unit 110, a camera unit 120, a display unit 130, and a gesture processing unit 140.

The input unit 110 is composed of a keypad or a touch screen, and recognizes a button input from a user.

The camera unit 120 includes at least one camera, and receives a gesture image of a user through the camera. Here, the camera is attached to the mobile terminal 100 in such a way, that the camera is incorporated in the mobile terminal or can be easily inserted into and separated from the mobile terminal. At this time, the camera is attached to the mobile terminal at a location where a gesture of a user can be recognized.

The display unit 130 is implemented by using a touch screen, a liquid crystal display (LCD), or an organic light emitting diode (OILED), and outputs application execution contents to a screen when an application, such as mobile browsing, is executed in the mobile terminal 100.

The gesture processing unit 140 recognizes gestures of a user and executes application functions corresponding to the gestures. That is, on the basis of a button input recognized by the input unit 110, the gesture processing unit 140 extracts gesture data from a user gesture image that is input from the camera unit 120, and executes an application function corresponding to the extracted gesture data when the extracted gesture data can be identified. In this case, the gestures of the user may include hand motions, face motions, and palm motions of the user.

Meanwhile, a method in which the gesture processing unit 140 recognizes gestures of a user may include a one-time recognition method and a continuous recognition method, The one-time recognition method is to recognize and process one gesture during a recognition interval and the continuous recognition method is to recognize and process one or more continuous gestures during a recognition interval. The recognition interval means an interval in which the mobile terminal 100 collects user gesture images input through the camera unit 120 and processes gesture data. In addition, various methods may be used as a method in which the mobile terminal 100 recognizes a recognition interval.

First, the gesture processing unit 140 can recognize the recognition interval as an interval in which a user continuously presses or touches a specific button on a keypad or a touch screen of the input unit 110 and a specific button input operation is continuously input.

For example, in the case of the mobile terminal 100 that includes a keypad, when a user presses a specific button that corresponds to a start of a recognition interval, the gesture processing unit 140 recognizes that the recognition interval starts. When the user stops pressing the corresponding button, the gesture processing unit 140 recognizes that the recognition interval ends. In the case of the mobile terminal 100 that includes a touch screen, when the user touches a specific region that corresponds to a specific button on the touch screen corresponding to a start of a recognition interval, the gesture processing unit 140 recognizes that the recognition interval starts. When the user stops touching the corresponding region, the gesture processing unit 140 recognizes that the recognition interval ends.

Second, when the user presses or touches a specific button on a keypad or touch screen of the input unit 110 that corresponds to a start of a recognition interval and a specific button input operation is recognized, the gesture processing unit 140 recognizes that the recognition interval starts. Then, when a predetermined time passes after the recognition interval starts or the user presses or touches the corresponding button again after the recognition interval starts, the gesture processing unit 140 recognizes that the recognition interval ends.

In the case of the mobile terminal 100 that includes a keypad, when the user presses a specific button corresponding to a start of the recognition interval, the gesture processing unit 140 recognizes that the recognition interval starts. When the user presses the corresponding button again after the recognition interval starts, the gesture processing unit 140 recognizes that the recognition interval ends. In the case of the mobile terminal 100 that includes a touch screen, when the user touches a specific region corresponding to a specific button on the touch screen that corresponds to a start of a recognition interval, the gesture processing unit 140 recognizes that the recognition interval starts. When the user touches the corresponding region again after the recognition interval starts, the gesture processing unit 140 recognizes that the recognition interval ends, Meanwhile, in the above-described exemplary embodiment of the present invention, button inputs that indicate a start and an end of the recognition interval are the same. However, the present invention is not limited thereto, and button inputs that indicate a start and an end of the recognition interval may be different from each other.

In order to process each of continuously input gestures, the gesture processing unit 140 needs to recognize a start point of time and an end point of time of each gesture on the basis of user gesture images input during the recognition interval. As a method that recognizes a start point of time and an end point of time of each of the gestures, a method of defecting motions of identifiers that are used to identify gestures in gesture images and a method of using a specific gesture may be used. The method that recognizes a start point of time and an end point of time of each gesture by detecting motions of identifiers can recognize a point of time when an identifier starts to show motions as a start point of time of each gesture, and a point of time when the identifier does not show motions for a predetermined time or disappears from the gesture image as an end point of time of each gesture. The method that recognizes a start point of time and an end point of time of each gesture using a specific gesture recognizes a point of time when a user implements a specific gesture informing a start of a gesture as a start point of time of each gesture, and a point of time when the user implements a specific gesture informing an end of a gesture as an end point of time of each gesture.

Meanwhile, in order to determine whether the extracted gesture data can be identified, the gesture processing unit 140 compares the extracted gesture data and at least one reference gesture data stored in the mobile terminal 100. Then, when there is reference gesture data that is matched with the extracted gesture data, the gesture processing unit 140 determines that the extracted gesture data can be identified and executes an application function that corresponds to the reference gesture data.

In this case, the reference gesture data means standard gesture data or user gesture data. The standard gesture data means the predetermined reference gesture data in the mobile terminal 100 and the user gesture data means reference gesture data that is registered by the user.

Meanwhile, in order to register the user gesture data, the gesture processing unit 140 extracts gesture data from the user gesture image using the above-described one-time recognition method and registers user gesture data. That is, the gesture processing unit 140 collects user gesture images during the recognition interval, and stores gesture data extracted from the collected user gesture images as user gesture data. The gesture processing unit 140 maps a specific application function to the corresponding user gesture data and registers the user gesture data. As such, the predetermined user gesture data is used as reference gesture data to determine whether a gesture of a user can be identified in the future. A method that uses user gesture data set by the user as the reference gesture data can execute an application function of the mobile terminal using a gesture that can be easily used for each user, which becomes convenient for the user.

Hereinafter, a mode in which the mobile terminal 100 recognizes a gesture of a user gesture and executes an application function corresponding to the recognized gesture is called a “gesture recognition mode”, and a mode in which user gesture data is set is called a “gesture registration mode”. Meanwhile, in order to discriminate between the gesture recognition mode and the gesture registration mode, a button input indicating a gesture input from a user in the gesture recognition mode needs to be set differently from a button input indicating a gesture input from the user in the gesture registration mode.

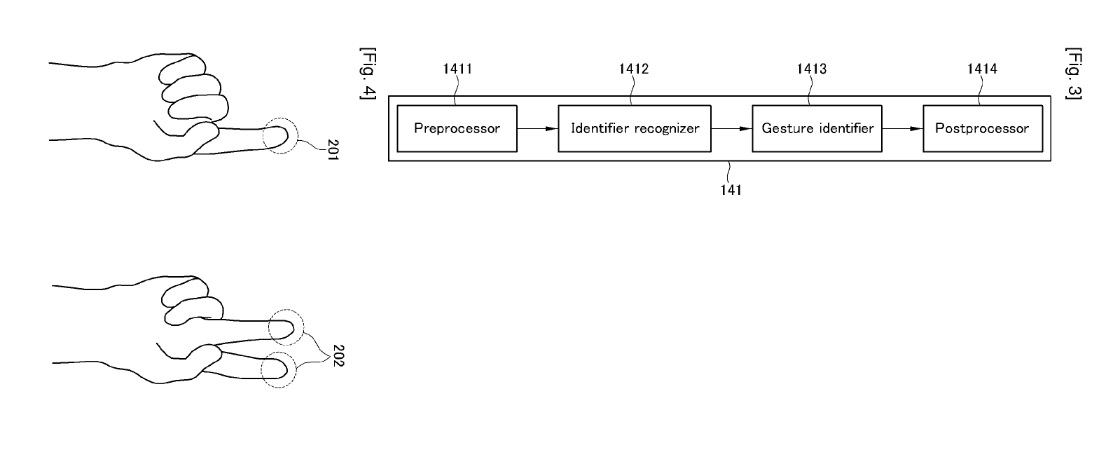

FIG. 2 is a configuration diagram illustrating a gesture processing unit 140 according to an exemplary embodiment of the present invention.

Referring to FIG. 2, the gesture processing unit 140 includes an image processor 141, a gesture analyzer 142, and a driver 143,

The image processor 141 collects user gesture images input through the camera unit 120 during a recognition interval, performs an image process such as noise removing and preprocessing on the collected gesture images, extracts gesture data from the image processed gesture images, and outputs the gesture data.

In the gesture recognition mode, the gesture analyzer 142 compares the extracted gesture data and at least one reference gesture data, and outputs a control instruction to execute an application function corresponding to reference gesture data matched with the extracted gesture data among the at least one reference gesture data. In the gesture registration mode, the gesture analyzer 142 registers the extracted gesture data as user gesture data, maps a specific application function to the corresponding user gesture data, and stores mapping information.

The driver 143 executes a corresponding application function in accordance with the control instruction output from the gesture analyzer 142. In this case, the application function means a mobile browser function and a mobile application function as functions that are incorporated in the mobile terminal 100.

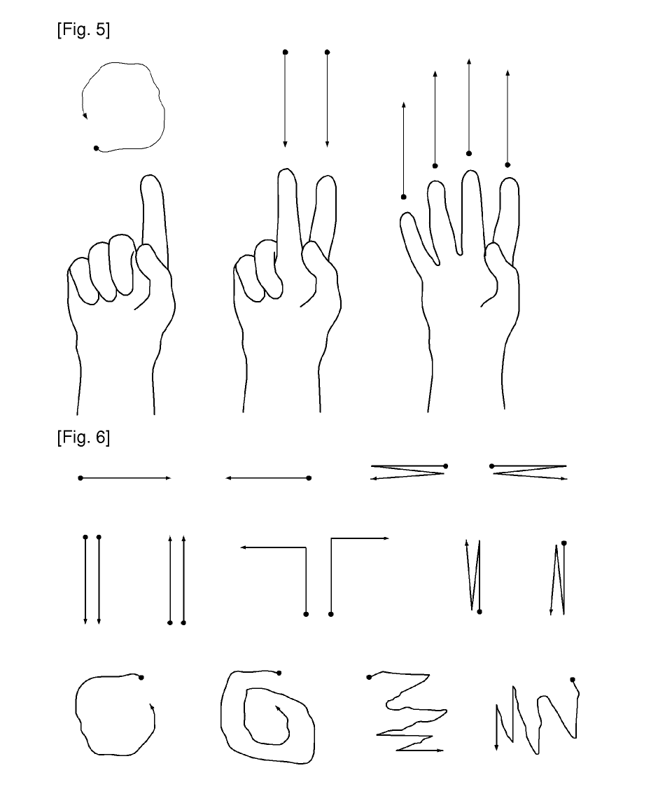

FIG. 3 is a configuration diagram illustrating an image processor 141 according to an exemplary embodiment of the present invention, FIG, 4 is a diagram illustrating examples of identifiers according to an exemplary embodiment of the present invention, and FIG. 5 is a diagram illustrating examples of motion information that is generated on the basis of positional changes of identifiers according to an exemplary embodiment of the present invention. FIG. 6 is a diagram illustrating examples of gesture data according to an exemplary embodiment of the present invention.

Referring to FIG. 3, the image processor 141 includes a preprocessor 1411, an identifier recognizer 1412, a gesture identifier 1413, and a postprocessor 1414.

The preprocessor 1411 normalizes a gesture image input through the camera unit 120, removes a noise from the gesture image, and outputs the gesture image.

The identifier recognizer 1412 extracts feature points corresponding to specific body portions used for gestures, such as fingers, a wrist, a palm, and a face, from the gesture image preprocessed by the preprocessor 1411, and recognizes identifiers in the gesture image on the basis of the extracted feature points. The identifier recognizer 1412 continuously records positional changes of the corresponding identifiers in the gesture image and generates motion information. For example, as shown in FIG. 4, if a user makes a trace using motions of one or two fingers to make a gesture during the recognition interval, the identifier recognizer 1412 extracts feature points from the gesture image input through the camera unit 120 and recognizes fingertips 201 and 202 of the user as identifiers. As shown in FIG. 5, the identifier recognizer 1412 records positional changes of the identifiers, that is, continuously records a trace different from the motions of the fingertips, thereby generating motion information.

The gesture identifier 1413 generates gesture data that includes motion information of identifiers generated by the identifier recognizer 1412. FIG. 6 shows examples of gestures input by a user, which shows positional changes of identifiers according to the gestures that are implemented by the user. Referring to FIG. 6, it is possible to implement various gestures using a three-dimensional direction from a start point of each gesture to an end point thereof, kinds of bends, and a rotation direction. In addition to the gestures shown in FIG. 6, a user can register his or her various gestures in the mobile terminal 100 and use the registered gestures.

The postprocessor 1414 performs a correction process on gesture data generated by the gesture identifier 1413 to remove unnecessary information and error and outputs finally recognized gesture data.

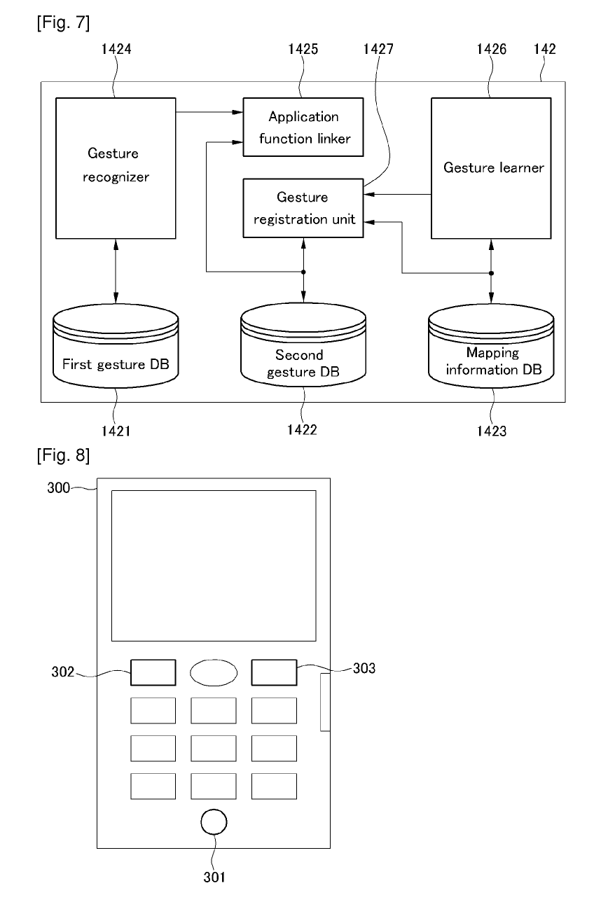

FIG. 7 is a configuration diagram illustrating a gesture analyzer 142 according to an exemplary embodiment of the present invention.

Referring to FIG. 7, the gesture analyzer 142 includes a first gesture database (DB) 1421, a second gesture DB 1422, a mapping information DB 1423, a gesture recognizer 1424, an application function linker 1425, a gesture learner 1426, and a gesture registration unit 1427.

The first gesture DB 1421 stores predetermined standard gesture data in the mobile terminal 100.

The second gesture DB 1422 stores user gesture data set by a user.

The mapping information DB 1423 stores mapping information for an application function that is mapped for each of the standard gesture data and the user gesture data stored in the first gesture DB 1421 and the second gesture DB 1422, respectively.

In the gesture recognition mode, the gesture recognizes 1424 searches reference gesture data that is matched with gesture data output from the image processor 141 among the reference gesture data stored in the first gesture DB 1421 and the second gesture DB 1422.

In the gesture recognition mode, when there is reference gesture data that is matched with the gesture data output from the image processor 141 among the reference gesture data, the application function linker 1425 reads information on an application function mapped to the corresponding reference gesture data from the mapping information DB 1423. The application function linker 1425 outputs a control instruction to execute the corresponding application function to the driver 143.

In the gesture registration mode, the gesture learner 1426 learns gesture data output from the image processor 141 and stores the corresponding gesture data as user gesture data in the second. gesture DB 1422. That is, in the gesture registration mode, the gesture learner 1426 confirms whether there is reference gesture data that is matched with the gesture data output from the image processor 141 among the reference gesture data stored in the first gesture DB 1421 and the second gesture DB 1422. When there is no reference gesture data matched with the gesture data, the gesture learner 1426 recognizes the corresponding gesture data as user gesture data and stores the corresponding gesture data in the second gesture DB 1422.

In the gesture registration mode, the gesture registration unit 1427 maps a specific application function to the user gesture data that the gesture learner 1426 stores in the second gesture DB 1422 and stores mapping information in the mapping information DB 1423.

Next, referring to FIGS. 8 to 12, examples of the mobile terminal 100 according to the exemplary embodiment of the present invention will be described.

FIG. 8 shows a first example of a mobile terminal 100 according to an exemplary embodiment of the present invention, which shows a bar-type mobile terminal 300 that includes a keypad and has a camera 301 incorporated therein.

Referring to FIG, 8, in the gesture recognition mode, the mobile terminal 300 recognizes gestures of the user input through the camera 301 during a recognition interval. Meanwhile, in the gesture registration mode, the mobile terminal 300 recognizes the gestures of the user input through the camera 301 during the recognition interval and registers user gesture data. At this time, the mobile terminal 300 differently sets buttons that are used to recognize recognition intervals of the gesture recognition mode and the gesture registration mode so as to discriminate between the gesture recognition mode and the gesture registration mode.

For example, in the gesture recognition mode, the mobile terminal 300 recognizes a recognition interval according to whether a first button 302 is pressed. In the gesture registration mode, the mobile terminal 300 recognizes a recognition interval according to whether a second button 303 is pressed.

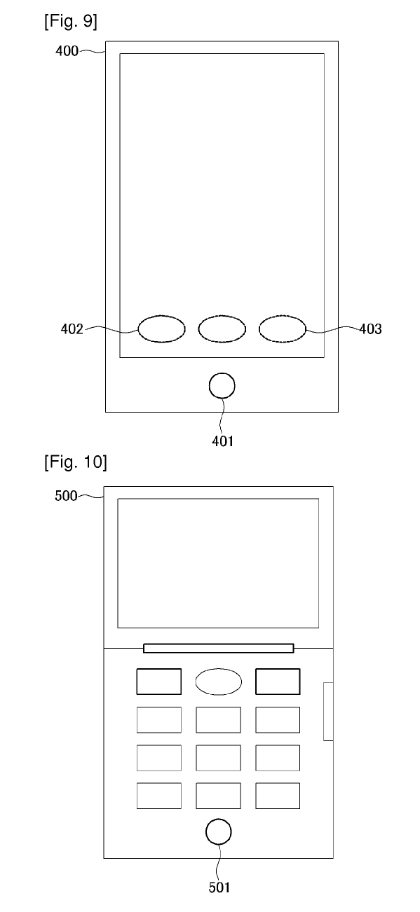

FIG. 9 shows a second example of a mobile terminal 100 according to an exemplary embodiment of the present invention, which shows a bar-type mobile terminal 400 that includes a touch screen and has a camera 401 incorporated therein.

Similar to the mobile terminal 300 that is shown in FIG. 8, the mobile terminal 400 that is shown in FIG. 9 recognizes gestures of the user, sets user gesture data, and receives a button input through the touch screen instead of the keypad. In this case, the mobile terminal 400 recognizes a specific region of the touch screen as a virtual button and recognizes a recognition interval on the basis of a button input that is generated by touching the corresponding specific region.

For example, the mobile terminal 400 may recognize gestures of the use by a one-time recognition method or a continuous recognition method on the basis of a button input that is generated by touching a first region 402, and set user gesture data on the basis of a button input that is generated by touching a second region 403.

FIG. 10 shows a third example of a mobile terminal 100 according to an exemplary embodiment of the present invention, which shows a folding-type mobile terminal 500 that includes a keypad and has a camera 501 incorporated therein.

In the same method as the mobile terminal 300 that is shown in FIG. 8, the mobile terminal 500 that is shown in FIG. 10 may recognize gestures of the user and set user gesture data.

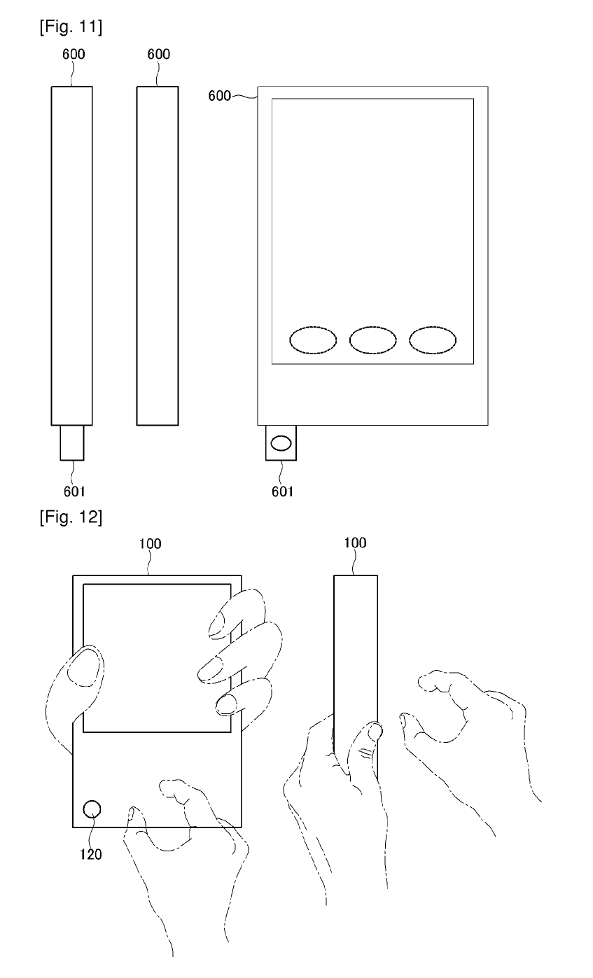

FIG. 11 shows a fourth example of a mobile terminal 100 according to an exemplary embodiment of the present invention, which shows a bar-type mobile terminal 600 that includes a touch screen and has a camera 601 freely inserted into or separated from the mobile terminal.

In the same method as the mobile terminal 400 that is shown in FIG. 9, the mobile terminal 600 that is shown in FIG. 11 may recognize gestures of the user and set user gesture data.

FIG. 12 shows an example of when a mobile terminal 100 according to an exemplary embodiment of the present invention recognizes gestures of a user.

Referring to FIG. 12, if a user presses a specific button on a keypad or touches a specific region on a touch screen, the mobile terminal 100 switches a mode into a gesture recognition mode or a gesture registration mode. Therefore, the user can move his/her fingers and input a gesture, as shown in FIG. 12.

The mobile terminals 300, 400, 500, and 600 that are shown in FIGS. 8 to 11 are only examples of the mobile terminal according to the exemplary embodiment of the present invention, and the present invention is not limited thereto. The present invention can implement the mobile terminal in various types in addition to the types according to the above-described exemplary embodiment. In FIGS. 8 to FIG. 11 that are described above, the cameras 301, 401, 501, and 601 are attached to the lower ends of the mobile terminals 300, 400, 500, and 600, respectively. However, the present invention is not limited thereto, and the cameras 301, 401, 501, and 601 may be attached to the mobile terminals at different locations in order to effectively recognize gestures of the user. In FIGS. 8 to 11, the cameras 301, 401, 501, and 601 are attached to the mobile terminals 300, 400, 500, and 600, respectively, to recognize gestures of the user. However, the present invention is not limited thereto, and a plurality of cameras May be attached to each of the mobile terminals 300, 400, 500, and 600 in order to effectively recognize gestures of the user. In FIGS. 8 to 11, the mobile terminal includes a keypad or a touch screen. However, the present invention is not limited thereto, and the present invention may be applied to a mobile terminal that includes both a keypad and a touch screen.

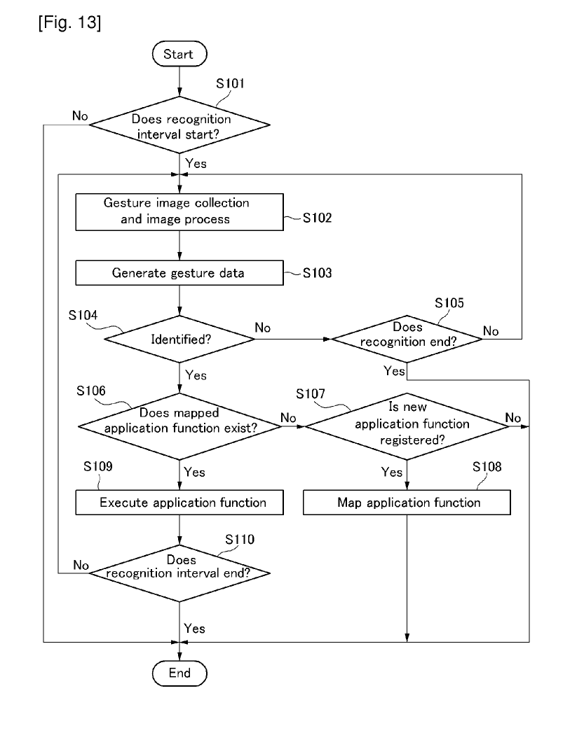

FIG. 13 is a flowchart illustrating a method of driving a mobile terminal 100 in a gesture recognition mode according to an exemplary embodiment of the present invention.

Referring to FIG. 13, if a user requests to recognize gestures, that is, a recognition interval to recognize the gestures starts (S101), the mobile terminal 100 collects user gesture images using the camera unit 120 and performs an image process on the collected gesture images (S104 in this case, the user presses a specific button on a keypad or touches a specific region on a touch screen in the mobile terminal 100 to switch a mode of the mobile terminal 100 into the gesture recognition mode. The mobile terminal 100 recognizes that a recognition interval to recognize gestures starts as the mode is switched into the gesture recognition mode.

Then, the mobile terminal 100 generates motion information where a positional change of an identifier is recorded on the basis of the gesture image on which the image process has been performed, and generates gesture data using the motion information (S103). Then, the mobile terminal confirms whether there is reference gesture data that is matched with the generated gesture data among the reference gesture data stored in the first gesture DB 1421 and the second gesture DB 1422, and determines whether the corresponding gesture data can be identified (S104).

When it is determined that it is not possible to search reference gesture data that is matched with the generated gesture data and the corresponding gesture data cannot be identified, the mobile terminal 100 confirms whether a user desires to end the gesture recognition (S105). When the user requests to end the gesture recognition, the mobile terminal 100 ends the recognition interval and releases the gesture recognition mode. Meanwhile, when the user requests to continuously perform the gesture recognition, the mobile terminal 100 collects gesture images again and performs an image process on the collected gesture images (S102) to generate gesture data (S103).

Meanwhile, when it is determined that it is possible to search reference gesture data that is matched with the generated gesture data and the corresponding gesture data can be identified, the mobile terminal 100 searches application mapping information for the reference gesture data matched with the generated gesture from the mapping information DB 1423 (S106). When there is no application function that is mapped to the corresponding reference gesture data as a search result, the mobile terminal 100 confirms that the user desires to map a new application function to the corresponding reference gesture data and register the new application function (S107). When the user requests to register the new application function, the mobile terminal 100 maps the application function selected by the user to the corresponding reference gesture data and stores mapping information in the mapping information DB 1423 (S108). Meanwhile, when there is an application function that is mapped to the reference gesture data matched with the generated gesture data, the mobile terminal 100 executes the corresponding application function (S109). Then, the mobile terminal 100 confirms Whether a recognition interval ends (S110). When the recognition interval does not end, the mobile terminal 100 repeats the above-described gesture recognition processes (S102 to 109).

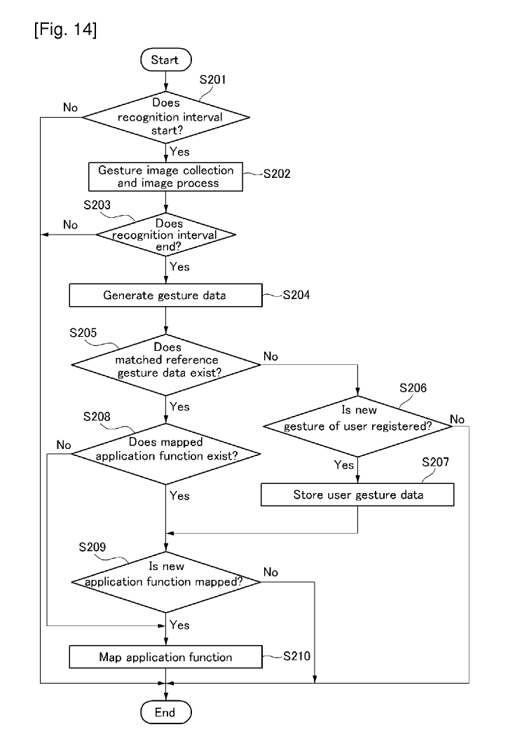

FIG. 14 is a flowchart illustrating a method in which a mobile terminal 100 registers gestures of a user in a gesture registration mode according to an exemplary embodiment of the present invention.

Referring to FIG. 14, when the user requests to register the gestures, that is, a recognition interval to register the gestures starts (S201), the mobile terminal 100 collects user gesture images using the camera unit 120 and performs an image process on the collected gesture images (S202). The gesture image collection process and the image process are continuously performed until the recognition interval ends (S203). In this case, the user presses a specific button on a key pad or touches a specific region on a touch screen in the mobile terminal 100 to switch a mode of the mobile terminal 100 into the gesture registration mode. The mobile terminal 100 recognizes that the recognition interval to register the gestures starts as the mode is switched into the gesture registration mode.

Then, the mobile terminal 100 analyzes the gesture images, which are collected during the recognition interval and on which an image process is performed, to generate motion information where a positional change of an identifier is recorded, and generates gesture data using the motion information (S204). The mobile terminal 100 confirms whether there is reference gesture data that is matched with the generated gesture data among the reference gesture data stored in the first gesture DB 1421 and the second gesture DB 1422 (S205).

As a confirmed result, when it is not possible to search the reference gesture data that is matched with the generated gesture data, the mobile terminal 100 confirms whether the user desires to register the corresponding gesture (S206). Then, when the user desires to register the corresponding gesture data, the mobile terminal 100 stores the corresponding gesture data as user gesture data in the second gesture DB 1422 (S207). When the user gesture data is registered, the mobile terminal 100 confirms whether the user desires to map a new application function to the corresponding user gesture data (S209). When the user desires to map the new application function, the mobile terminal 100 maps the application function selected by the user to the corresponding user gesture data and stores mapping information in the mapping information DB 1423 (S210).

Meanwhile, when it is possible to search reference gesture data that is matched with the generated gesture data, the mobile terminal 100 confirms whether the user desires to change the application function mapped to the corresponding reference gesture data to a new application function (S209). Then, when the use desires to map the new application function, the mobile terminal 100 maps the application function selected by the user to the corresponding reference gesture data and stores the mapping information in the mapping information DB 1423 (S210).

Meanwhile, in the exemplary embodiment of the present invention, when new gesture data that is different from the previously stored reference gesture data is input, the mobile terminal 100 confirms whether the user desires to register the new gesture data (S206). When the user desires to register the new gesture data, the mobile terminal 100 registers the user data (S207). However, the present invention is not limited thereto. In the present invention, when new gesture data that is different from the previously stored reference gesture data is input, the mobile terminal confirms whether the user desires to map an application function to the corresponding gesture data. When the user desires to map the application function, the mobile terminal may store the corresponding gesture data and map the application function selected by the user to the corresponding gesture data.

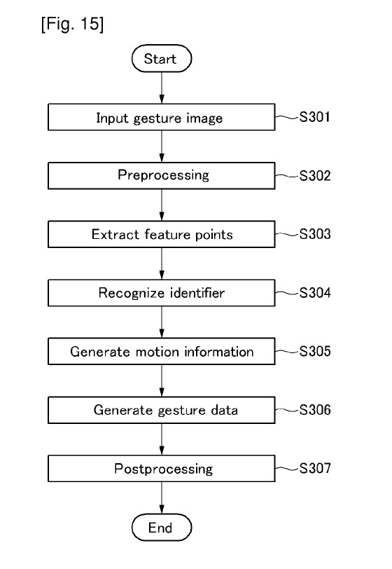

FIG. 15 is a flowchart illustrating a method in which a mobile terminal 100 according to an exemplary embodiment of the present invention generates gesture data.

Referring to FIG. 15, when the mobile terminal 100 receives a user gesture image through the camera unit 120 during the recognition interval (S301) after the mode is switched into the gesture recognition mode or the gesture registration mode, the mobile terminal 100 normalizes the input gesture image and performs preprocessing on the gesture image to remove unnecessary noise (S302).

Then, the mobile terminal 100 analyzes the preprocessed gesture image to extract feature points needed to recognize an identifier (S303). The mobile terminal 100 recognizes the identifier on the basis of the extracted feature points (S304), calculates a positional change of the identifier in the gesture image on the basis of absolute coordinates, and generates motion information based. on the positional change (S305). The mobile terminal 100 uses the generated motion information to generate gesture data (S306) and performs postprocessing to remove unnecessary information from the generated gesture data (S307), thereby generating finally recognized gesture data.

The exemplary embodiment of the present invention that has been described above may be implemented by not only an apparatus and a method but also a program capable of realizing a function corresponding to the structure according, to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A mobile terminal driving method that drives a mobile terminal, which has a camera attached thereto and recognizes gestures of a user, the mobile terminal driving method comprising:
collecting gesture images through the camera;
generating gesture data that includes motion information where positional changes of identifiers in the collected gesture images are recorded; and
when the gesture data can be identified, searching an application function mapped to the gesture data and executing the searched application function.

2. The mobile terminal driving method of claim 1, further comprising:
determining when a recognition interval starts on the basis of a button input, wherein the collecting of the gesture images is collecting the gesture images when the recognition interval starts.

3. The mobile terminal driving method of claim 2, further comprising:
determining when the recognition interval ends on the basis of a button input, wherein the generating of the gesture data, the searching of the application function mapped to the gesture data, and the executing of the searched application function are repeated until the recognition interval ends.

4. The mobile terminal driving method of claim 3, wherein a point of time when a first button input starts is recognized as a point of time when the recognition interval starts, and a point of time when the first button input ends is recognized as a point of time when the recognition interval ends.

5. The mobile terminal driving method of claim 3, wherein it is recognized that the recognition interval starts when a first button input operation is input, and it is recognized that the recognition interval ends when a predetermined time passes after the recognition interval starts.

6. The mobile terminal driving method of claim 3, wherein it is recognized that the recognition interval starts when a first button input operation is input, and it is recognized that the recognition interval ends when the recognition interval starts and a second button input operation is input.

7. The mobile terminal driving method of claim 1, wherein the generating of the gesture data includes:
recognizing the identifiers on the basis of at least one feature point in the collected gesture images;
recording the positional changes of the identifiers to generate the motion information; and
generating the gesture data including the motion information,

8. The mobile terminal driving method of claim 7, wherein the recognizing of the identifiers includes:
performing a noise removing process and a regulating process on the collected gesture images; and
analyzing the gesture images on which the noise removing process and the regulating process have, been performed and extracting the at least one feature point corresponding to a specific part of a body.

9. The mobile terminal driving method of claim 1, further comprising:
searching data matched with the gesture data among at least one reference gesture data that is stored in advance and determining whether the gesture data can be identified.

10. The mobile terminal driving method of claim 1, further comprising:
when the application function mapped to the gesture data is not searched, confirming whether the user desires to map an application function to the gesture data; and
when the user requests to map the application function, mapping the application function selected by the user to the gesture data and storing mapping information.

11. A reference gesture registering method in which a mobile terminal having a camera attached thereto registers reference gesture data that is used as a reference when identifying gestures of a user, the reference gesture registering method comprising:
collecting gesture images through the camera during a recognition interval;
analyzing the collected gesture images to extract at least one feature point;
recording positional changes of identifiers recognized on the basis of the at least one feature point and generating motion information;
generating gesture data including the motion information; and
mapping an application function selected by the user to the gesture data and storing mapping information.

12. The reference gesture registering method of claim 1, further comprising:
searching reference gesture data matched with the gesture data among at least one reference gesture data that is stored in advance;
when the reference gesture data matched with the gesture data is searched, confirming whether the user desires to change an application function mapped to the gesture data; and
when the user requests to change the mapped application function, mapping the application function selected by the user to the gesture data and storing mapping information.

13. The reference gesture registering method of claim 11, wherein the recognition interval is determined on the basis of a button input on the mobile terminal.

14. A mobile terminal comprising:
an image processor that uses positional changes of identifiers in gesture images of a user input through a camera attached to the mobile terminal to extract gesture data;
a gesture analyzer that outputs a control instruction to drive an application function mapped to reference gesture data matched with the gesture data, when there is the reference gesture data matched with the gesture data among at least one reference gesture data that is previously stored in the mobile terminal; and
a driver that executes the application function on the basis of the control instruction.

15. The mobile terminal of claim 14, further comprising:
an input unit that recognizes a button input from the user;
wherein the image processor recognizes a recognition interval on the basis of the button input recognized by the input unit and extracts the gesture data from the gesture images during the recognition interval.

16. The mobile terminal of claim 15, wherein the image processor includes:
an identifier recognizer that recognizes the identifiers on the basis of at least one feature point extracted from the gesture images during the recognition interval and records positional changes of the identifiers to generate motion information; and
a gesture identifier that generates the gesture data including the motion information.

17. The mobile terminal of claim 16, wherein the image processor further includes a preprocessor that performs preprocessing corresponding to noise removing and normalizing on the gesture images and outputs the results to the identifier recognizer, and the identifier recognizer uses the preprocessed gesture images to generate the motion information.

18. The mobile terminal of claim 14, wherein the gesture analyzer includes:
a gesture database that stores the at least one reference gesture data;
a mapping information database that stores mapping information on an application function mapped to the at least one reference gesture data;
a gesture recognizer that searches reference gesture data matched with the gesture data among the at least one reference gesture data stored in the gesture database; and
an application function linker that generates the control instruction on the basis of the mapping information on the application function mapped to the reference gesture data matched with the gesture data that is read from the mapping information database.

19. The mobile terminal of claim 18, wherein the gesture database includes:
a first gesture database that stores predetermined standard gesture data in the mobile terminal; and
a second gesture database that stores user gesture data set by the user, and
the at least one reference gesture data is the standard gesture data or the user gesture data.

20. The mobile terminal of claim 19, wherein the gesture analyzer further includes:
a gesture learner that stores the gesture data in the second gesture database, when there is no reference gesture data matched with the gesture data among the at least one reference gesture data stored in the gesture database; and
a gesture registration unit that maps an application function to the gesture data, and registers mapping information on the application function mapped to the gesture data in the mapping information database.
